(19) United States
(12) Patent Application Publication
(10) Pub. No.: US 2026/0265053 A1
(43) Pub. Date: Sep. 10, 2026

(54) PROCESS FOR PRODUCING HYDROGEN

(71) Applicant: Johnson Matthey Davy Technologies Limited, London (GB)

(72) Inventors: Mileta BABOVIC, Billingham Cleveland (GB); Michiel NIJEMEISLAND, Billingham Cleveland (GB); Iain James Olson ROBERTS, Stockton-On-Tees Cleveland (GB); Majid SADEQZADEH BOROUJENI, Billingham Cleveland (GB)

(21) Appl. No.: 19/120,104

(22) PCT Filed: Dec. 15, 2023
(86) PCT No.: PCT/GB2023/053258

§ 371 Date: Apr. 10, 2025

(30) Foreign Application Priority Data
Dec. 21, 2022 (GB) 2219361.9

(51) Int. Cl. C01B 3/48; B01D 53/02; B01D 53/14; B01D 53/26; B01J 8/04; C01B 3/506

(52) U.S. Cl. CPC C01B 3/48; B01D 53/1475; B01D 53/265; B01J 8/0492; B01J 8/0496; C01B 3/506; B01D 53/02; B01D 2252/20489; B01D 2256/16; B01D 2257/504; B01D 2257/80; B01J 2208/00504; C01B 2203/0233; C01B 2203/0244; C01B 2203/0283; C01B 2203/046; C01B 2203/0475; C01B 2203/0495; C01B 2203/0827; C01B 2203/1235; C01B 2203/127; C01B 2203/143; C01B 2203/148

(57) ABSTRACT

The invention relates to process for the production of hydrogen comprising the steps of: hydrodesulphurisation, reforming in an autothermal reformer, water-gas shift, carbon dioxide separation, and hydrogen purification. The hydrogen purification step produces a hydrocarbon-containing off-gas stream which is split: a portion is used as a fuel gas stream which is fed to one or more fired heaters used to heat one or more process streams within the process, the remainder is compressed and split into a hydrodesulphurisation recycle stream which is used in the hydrodesulphurisation unit, and a process recycle stream which is returned to the process. The invention also relates to a chemical plant configured to carry out the process.

### TECHNICAL FIELD

This invention relates to processes for the conversion of hydrocarbons to hydrogen whilst minimising carbon dioxide production.

### BACKGROUND TO THE INVENTION

Processes for generating hydrogen are well-known and generally include a fired steam methane reformer combined with water-gas shift and carbon dioxide (CO₂) removal. Such processes create significant volumes of carbon dioxide in flue gases at pressures unsuitable for efficient CO₂ capture. There is a need for hydrogen production processes that generate lower levels of carbon dioxide effluent and enable more efficient CO₂ capture.

In some processes a fired reformer is used to generate a synthesis gas. In a fired reformer fuel is combusted within a radiant box of the fired reformer to provide heat to drive the steam reforming reactions. For example, US2009/0230359A1 discloses a method for generating hydrogen and/or syngas in a production facility where little or no export steam is produced. Most or all of the steam produced from the waste heat from the process is used in the steam-hydrocarbon reformer. The flowsheet shown in FIG. 1 of this reference includes a fired steam reformer (650), optional water-gas shift reactor (602), and pressure swing adsorber (330). The pressure swing adsorber generates a residual gas (698) which is divided. A portion (630) is used as fuel in the fired steam reformer. Another portion is compressed and used as feedstock for the fired steam reformer, optionally after first being treated to hydrodesulfurization and/or pre-reforming.

As another example, US2012/0039794A1 describes a process for producing hydrogen. The flowsheet shown in FIG. 1 of this reference includes a fired steam reformer (14), a shift vessel (34), a CO₂-selective membrane shift reactor (40), a water separator (58), and a pressure swing adsorption apparatus (64). The pressure swing adsorption apparatus generates a high purity hydrogen product and a purge stream, which is purified and then used as part of the feedstock for the fired steam reformer.

In an alternative process an autothermal reformer is used instead of a fired reformer. For example, US2004/0028595A1 describes a method for producing ammonia from natural gas. The flowsheet shown in FIG. 1 of this reference includes a pre-treatment unit (40), an autothermal reformer (3), a shift conversion stage (10), a CO₂ adsorber (14a). A partially purified synthesis gas generated by the CO₂ adsorber is passed to a fine screening unit (23a) which generates several streams: a synthesis gas which is fed to the ammonia synthesis section; a CO₂-containing stream which is recycled upstream of the shift stage; and a methane-containing stream which is recycled to the pre-treatment unit.

WO2022/038089A1 describes a plant and process for producing hydrogen rich gas, comprising the steps of: reforming a hydrocarbon feed by optional pre-reforming, autothermal reforming (ATR), yet no primary reforming, thereby obtaining a synthesis gas; shifting said synthesis gas in a shift section including a high temperature shift step; removal of CO₂ upstream of a hydrogen purification unit, thereby producing a hydrogen rich stream and an off-gas stream, and where at least part of the off-gas stream is recycled to the process, to the ATR and optional pre-reforming, and/or to the shift section.

WO2022/003313A1 describes a process for the production of hydrogen comprising the steps of: (i) subjecting a gaseous mixture comprising a hydrocarbon and steam, and having a steam to carbon ratio of at least 0.9:1, to adiabatic pre-reforming in a pre-reformer followed by autothermal reforming with an oxygen-rich gas in an autothermal reformer to generate a reformed gas mixture; (ii) increasing the hydrogen content of the reformed gas mixture by subjecting it to one or more water-gas shift stages in a water-gas shift unit to provide a hydrogen-enriched reformed gas; (iii) cooling the hydrogen-enriched reformed gas and separating condensed water therefrom to provide a de-watered hydrogen-enriched reformed gas; (iv) passing the de-watered hydrogen-enriched reformed gas to a carbon dioxide separation unit to provide a carbon dioxide gas stream and a crude hydrogen gas stream, and (v) passing the crude hydrogen gas stream from the carbon dioxide removal unit to a purification unit to provide a purified hydrogen gas and a fuel gas, wherein the fuel gas is fed to one or more fired heaters used to heat one or more process streams within the process. In a worked example a natural gas feed stream comprising >85 vol % methane is combined with a H₂ stream taken from the purified hydrogen gas stream produced by the purification unit and sent to a hydrodesulfurisation vessel. While the above process has a good efficiency with a very high rate of carbon dioxide capture, there is a need for a hydrogen production process with a even higher yield of hydrogen per unit of hydrocarbon feed. The present invention addresses this problem.

### SUMMARY OF THE INVENTION

The inventors have improved the process described in WO2022/003313A1 to increase the yield of H₂ per unit of hydrocarbon feed. Accordingly the invention provides a process for the production of hydrogen comprising the steps of:
(i) passing a hydrogen stream (220, 320, 420, 520) and a feed stream comprising hydrocarbons (201, 301, 401, 501) to a hydrodesulphurisation unit (203, 303, 403, 503) and carrying out hydrodesulphurisation to produce a purified hydrocarbon stream;
(ii) adding steam (204, 304, 404, 504) to the purified hydrocarbon stream to produce a gaseous mixture comprising hydrocarbons and steam (205, 305, 405, 505);
(iii) subjecting the gaseous mixture comprising hydrocarbons and steam to steam reforming in a reforming section (207, 307, 407, 507) comprising an autothermal reformer to generate a reformed gas mixture (208, 308, 408, 508);
(iv) increasing the hydrogen content of the reformed gas mixture by subjecting it to one or more water-gas shift stages in a water-gas shift section (210, 310, 410, 510) to provide a hydrogen-enriched reformed gas (211, 311, 411, 511);
(v) cooling the hydrogen-enriched reformed gas and separating condensed water therefrom to provide a de-watered hydrogen-enriched reformed gas;
(vi) passing the de-watered hydrogen-enriched reformed gas to a carbon dioxide separation unit (212, 312, 412, 512) to provide a carbon dioxide gas stream (213, 313, 413, 513) and a crude hydrogen gas stream (214, 314, 414, 514);
(vii) passing the crude hydrogen gas stream from the carbon dioxide removal unit to a purification unit (215, 315, 415, 515) to provide a purified hydrogen gas stream (216, 316, 416, 516) and a hydrocarbon-containing off-gas stream (217, 317, 417, 517);
(viii) splitting the off-gas stream into a fuel gas stream (218, 318, 418, 518) and a recycle stream (219, 319, 419, 519), wherein the fuel gas stream is fed to one or more fired heaters used to heat one or more process streams within the process;
(ix) compressing the recycle stream;
(x) splitting the compressed recycle stream into a hydrodesulphurisation recycle stream (220, 320, 420, 520) and a process recycle stream (221, 321, 421, 521);
(xi) feeding the hydrodesulphurisation recycle stream to the hydrodesulphurisation unit;
(xii) returning the process recycle stream to one or more locations selected from:
(xii-a) downstream from the hydrodesulphurisation unit and upstream from the autothermal reformer;
(xii-b) downstream from the autothermal reformer and upstream from the water-gas shift section;
(xii-c) downstream from the water-gas shift section and upstream from the carbon dioxide separation unit; or
(xii-d) downstream from the carbon dioxide separation unit and upstream from the purification unit.

The present process differs from the arrangement in WO2022/003313A1 in two significant ways. Firstly, whereas in the prior art arrangement all of the off-gas from the purification unit is combusted as fuel in one or more fired heaters, in the present invention the off-gas from the purification unit is split into a fuel gas stream and a recycle stream. The fuel gas stream is fed to one or more fired heaters used to heat one or more process streams within the process. The recycle stream, containing some unreacted hydrocarbons, is compressed and then split into a hydrodesulphurisation recycle stream and a process recycle stream which are both returned to the process. The hydrodesulphurisation recycle stream provides the hydrogen required in the hydrodesulphurisation unit, instead of taking a portion of the hydrogen product stream from the purification unit, as in the prior art arrangement. This improves overall H₂ yield. The process recycle stream is returned at one or more of locations (xii-a) to (xii-d). Surprisingly, despite the added complexity of this arrangement, the total hydrogen efficiency of the process (H₂ produced per unit of hydrocarbon feed) is increased. This is achieved without sacrificing the efficiency of CO₂ capture, which can be 98% or higher in the process of the invention.

In a second aspect the invention relates to a chemical plant comprising:
(i) a hydrodesulphurisation unit (203, 303, 403, 503) arranged to accept a hydrogen stream (220, 320, 420, 520) and a feed stream comprising hydrocarbons (201, 301, 401, 501) and to carry out hydrodesulphurisation to produce a purified hydrocarbon stream;
(ii) means for adding steam (204, 304, 404, 504) to the purified hydrocarbon stream to produce a gaseous mixture comprising hydrocarbons and steam (205, 305, 405, 505);
(iii) a reforming section (207, 307, 407, 507) comprising an autothermal reformer, arranged to accept said gaseous mixture comprising hydrocarbons and steam to produce a reformed gas mixture (208, 308, 408, 508);
(iv) a water-gas shift section (210, 310, 410, 510) comprising one or more water-gas shift stages arranged to accept said reformed gas mixture to produce a hydrogen-enriched reformed gas (211, 311, 411, 511);
(v) means for cooling the hydrogen-enriched reformed gas and separating condensed water therefrom to produce a de-watered hydrogen-enriched reformed gas;
(vi) a carbon dioxide separation unit (212, 312, 412, 512) arranged to accept said de-watered hydrogen-enriched reformed gas to produce a carbon dioxide gas stream (213, 313, 413, 513) and a crude hydrogen gas stream (214, 314, 414, 514);
(vii) a purification unit (215, 315, 415, 515) arranged to accept said crude hydrogen gas stream and to produce a purified hydrogen gas stream (216, 316, 416, 516) and a hydrocarbon-containing off-gas stream (217, 317, 417, 517);
(viii) means for splitting the off-gas stream into a fuel gas stream (218, 318, 418, 518) and a recycle stream (219, 319, 419, 519), wherein the fuel gas stream is fed to one or more fired heaters used to heat one or more process streams within the process;
(ix) means for compressing the recycle stream;
(x) means for splitting the compressed recycle stream into a hydrodesulphurisation recycle stream (220, 320, 420, 520) and a process recycle stream (221, 321, 421, 521);
(xi) means for feeding the hydrodesulphurisation recycle stream to the hydrodesulphurisation unit;
(xii) means for returning the process recycle stream to one or more locations selected from:
(xii-a) downstream from the hydrodesulphurisation unit and upstream from the autothermal reformer;
(xii-b) downstream from the autothermal reformer and upstream from the water-gas shift section;
(xii-c) downstream from the water-gas shift section and upstream from the carbon dioxide separation unit; or
(xii-d) downstream from the carbon dioxide separation unit and upstream from the purification unit.

The chemical plant may be built from scratch (e.g. a “grassroots” chemical plant). Alternatively, an existing chemical plant may be retrofitted with the necessary units and associated piping etc. to produce a chemical plant according to the invention.

The chemical plant is preferably a hydrogen plant, i.e. produces hydrogen as the end product.

### DESCRIPTION OF THE FIGURES

FIG. 1 is a simplified illustration of the process described in WO2022/003313A1. A hydrocarbon stream (101) and a hydrogen stream (102) are fed to a desulphurisation unit (103). Steam (104) is added to the output from the desulphurisation unit to produce a stream (105) with a steam to carbon ratio of at least 0.9:1 which is sent to a reforming section (107). The reforming section includes a pre-reformer and an autothermal reformer. Steam (104) is added so that the feed to the autothermal reformer has a steam to carbon ratio of 1.30:1. An oxygen-rich gas stream (106) is also fed to the autothermal reformer. Steam reforming reactions take place in the autothermal reformer to produce a reformed stream (108). The reformed stream may optionally be mixed with additional steam (109) (note used in arrangement modelled) and sent to a water-gas shift section (110) to generate a hydrogen-rich reformed gas (111). The hydrogen-rich reformed gas is fed to a carbon dioxide separation unit (112) where it is separated into a carbon dioxide gas stream (113) and a crude hydrogen gas stream (114). The crude hydrogen gas stream is sent to a purification unit (115) where it is separated into a purified hydrogen gas stream (116) and an off-gas stream (117). The off-gas stream is used as a fuel gas.

FIG. 2 shows an arrangement according to the invention which is based on the arrangement shown in FIG. 1. The off-gas stream (217) is split to produce a fuel gas stream (218) and a recycle stream (219). The recycle stream is compressed (not shown) and then split into a desulphurisation recycle stream (220) which is fed to the purification unit and a process recycle stream (221) which is reintroduced to the process downstream from the desulphurisation unit (203) and upstream from the autothermal reformer (207).

FIG. 3 shows an arrangement according to the invention which is based on the arrangement shown in FIG. 1. The off-gas stream (317) is split to produce a fuel gas stream (318) and a recycle stream (319). The recycle stream is compressed (not shown) and then split into a desulphurisation recycle stream (320) which is fed to the desulphurisation unit and a process recycle stream (321) which is reintroduced to the process downstream from the autothermal reformer (307) and upstream from the water-gas shift section (310).

FIG. 4 shows an arrangement according to the invention which is based on the arrangement shown in FIG. 1. The off-gas stream (417) is split to produce a fuel gas stream (418) and a recycle stream (419). The recycle stream is compressed (not shown) and then split into a desulphurisation recycle stream (420) which is fed to the desulphurisation unit and a process recycle stream (421) which is reintroduced to the process downstream from the water-gas shift section (410) and upstream from the carbon dioxide separation unit (412).

FIG. 5 shows an arrangement according to the invention which is based on the arrangement shown in FIG. 1. The off-gas stream (517) is split to produce a fuel gas stream (518) and a recycle stream (519). The recycle stream is compressed (not shown) and then split into a desulphurisation recycle stream (520) which is fed to the desulphurisation unit and a process recycle stream (521) which is reintroduced to the process downstream from the carbon dioxide separation unit (512) and upstream from the purification unit (515).

### DETAILED DESCRIPTION OF THE INVENTION

Sub-headings are included for clarity purposes but are not intended to limit the invention.

Features concerning the arrangement of the chemical plant described in connection with the process also apply to the chemical plant according to the second aspect of the invention.

### Treatment Prior to Autothermal Reformer

The gaseous mixture fed to the autothermal reformer comprises hydrocarbons and steam. It is preferred that this mixture comprises ≥90 vol % methane, based on the % of hydrocarbons present in the mixture and excluding any steam, such as ≥95 vol % methane. A hydrocarbon-containing feed is pre-treated upstream of the autothermal reformer in order to remove contaminants, including at least a step of hydrodesulphurisation.

A wide variety of feeds may be used, such as natural gas, associated gas, LPG, petroleum distillate, diesel, naphtha or mixtures thereof, or hydrocarbon-containing off-gases from chemical processes, such as a refinery off-gas or a pre-reformed gas.

### Hydrodesulphurisation

Step (i) involves passing a hydrogen stream and a feed stream comprising hydrocarbons to a hydrodesulphurisation unit and carrying out hydrodesulphurisation to produce a purified hydrocarbon stream.

The feed stream may be compressed before or after hydrodesulphurisation, preferably before hydrodesulphurisation. The feed may be compressed to a pressure in the range 10-100 bar abs. The pressure of the feed stream may usefully govern the pressure throughout the process. The operating pressure is preferably in the range 15-50 bar abs, more preferably 25-50 bar abs as this provides an enhanced performance from the process.

The hydrodesulphurisation step is typically catalytic hydrodesulphurisation which may be achieved using known catalysts, such as CoMo or NiMo catalysts. This process generates hydrogen sulphide which is absorbed using a suitable hydrogen sulphide adsorbent, e.g. a zinc oxide adsorbent. An ultra-purification adsorbent may usefully be used downstream of the hydrogen sulphide adsorbent to further protect the steam reforming catalyst. Suitable, ultra-purification adsorbents may comprise copper-zinc oxide/alumina materials and copper-nickel-zinc oxide/alumina materials. To facilitate hydrodesulphurisation and/or reduce the risk of carbon laydown in the reforming process, hydrogen is preferably added to the compressed hydrocarbon. The amount of hydrogen in the resulting mixed gas stream may be in the range 1-20% vol, but is preferably in the range 1-10% vol, more preferably in the range 1-5% vol on a dry gas basis. In a preferred embodiment, a portion of the desulphurisation recycle stream (as described below) may be mixed with the compressed hydrocarbon.

The hydrogen stream to the hydrodesulphurisation unit is provided at least in part by the hydrodesulphurisation recycle stream which is separated in step (x) as described below. Although additional hydrogen may be added to the hydrodesulphurisation stream, the hydrodesulphurisation recycle stream is preferably fed to the hydrodesulphurisation unit without addition of supplemental hydrogen in order to maximise the hydrogen yield. In the latter case the hydrogen stream and hydrodesulphurisation recycle stream are one and the same.

Compared to the arrangement described in WO2022/003313A1, in which a portion of the crude hydrogen gas stream (from the carbon dioxide separation unit) or the purified hydrogen gas stream (from the purification unit) may be used to provide the hydrogen for desulfurisation, this arrangement uses a different, less hydrogen-rich feed. This helps to improve the yield of hydrogen per unit of hydrocarbon feed.

If the feed contains other contaminants, such as chloride or heavy metal contaminants, these may be removed, prior to reforming, either upstream or downstream of hydrodesulphurisation, using conventional adsorbents. Adsorbents suitable for chloride removal are known and include alkalised alumina materials. Similarly, adsorbents for heavy metals such as mercury or arsenic are known and include copper sulphide materials.

The feed may be pre-heated in one or more stages. It is preferably pre-heated after compression and before desulphurisation. Various hot gas sources are provided in the present process that may be used for this duty. For example, the feed may be heated in heat exchange with a shifted gas stream recovered from a water-gas shift stage, preferably a high-temperature shift stage. The desulphurised feed, also referred to herein equivalently as the purified hydrocarbon stream, may, for example, be heated in a fired heater fuelled by the fuel gas.

### Steam Addition

Step (ii) involves adding steam to the purified hydrocarbon stream to produce a gaseous mixture comprising hydrocarbons and steam. The steam introduction may be performed by direct injection of steam and/or by saturation of the purified hydrocarbon stream by contact with a stream of heated water. The steam added in step (ii) is preferably generated by combusting the fuel gas stream in the one or more fired heaters. In a preferred embodiment, the gaseous mixture comprising the hydrocarbon and steam is formed by directly mixing the purified hydrocarbon stream with steam, preferably steam generated in the one or more fired heaters and/or from cooling the reformed gas mixture with water.

The steam to carbon ratio (defined as the steam to hydrocarbon carbon ratio at the inlet to the autothermal reformer) may vary over a wide range, but is typically from 0.9:1 to 3.5:1, such as 0.9:1 to 2.4:1. For the avoidance of doubt, a feed containing 75 mol % H₂O and 25 mol % CH₄ has a steam to carbon ratio of 3.0:1, a feed containing 75 mol % H₂O, 23 mol % and 2 mol % has a steam to carbon ratio of 2.8:1 and so on. Operating the reforming section at a steam to carbon ratio in the range of 0.9:1 to 2.4:1 has the advantage that the heating requirement and oxygen demand for the reforming stages is reduced and that the front-end equipment (e.g. fired heater, pre-reformer, and autothermal reformer) will be smaller and lower in cost, but typically will require further steam addition to the reformed gas mixture upstream of the water-gas shift section. In one embodiment the steam to carbon ratio of the gaseous mixture comprising hydrocarbons and steam at the inlet to the autothermal reformer in step (iii) is from 0.9:1 to 2.4:1, and further steam is added to the reformed gas mixture upstream of the water-gas shift section. Where the steam to carbon ratio is in the range 2.4:1 to 3.5:1, no further steam addition upstream of the water-gas section is typically necessary, which may be useful in circumstances where steam addition to the reformed gas is impractical. If a pre-reformer is present, then the steam to carbon ratio at the inlet to the pre-reformer is preferably from 0.9:1 to 3.5:1, preferably from 0.9:1 to 2.4:1.

The gaseous mixture comprising hydrocarbon and steam is then desirably pre-heated prior to reforming. In a preferred embodiment, the gaseous mixture is heated by passing it through a fired heater fuelled by at least a portion of the fuel gas, in particular through the same fired heater used to pre-heat the hydrocarbon. Desirably, the mixed stream is heated to 400-500° C., preferably 420-460° C.

### Pre-Reforming

The gaseous mixture fed to autothermal reformer preferably comprises ≥90 vol % methane, based on the % of hydrocarbons present in the mixture and excluding any steam. Although not generally necessary for light gaseous hydrocarbons feedstocks, where hydrocarbon feedstocks contain higher hydrocarbons, it may be preferable in some instances to include a stage of adiabatic pre-reforming upstream of the autothermal reformer. The gaseous mixture comprising the hydrocarbon and steam in these cases is first subjected to a step of adiabatic steam reforming in a pre-reformer vessel. In such a process, the gaseous mixture comprising the hydrocarbon and steam, typically at an inlet temperature in the range of 400-650° C., is passed adiabatically through a bed of a steam reforming catalyst, usually a steam reforming catalyst having a high nickel content, for example above 40% by weight. During such an adiabatic pre-reforming step, any hydrocarbons higher than methane react with steam to give a mixture of methane, carbon oxides and hydrogen. The use of such an adiabatic steam reforming step, commonly termed pre-reforming, can be desirable to ensure that the feed to the autothermal reformer contains no hydrocarbons higher than methane and also contains some hydrogen. Therefore, in a preferred embodiment the process includes a step of pre-reforming either upstream from the hydrodesulphurisation unit, or downstream from the hydrodesulphurisation unit and upstream from the ATR. The pre-reforming is preferably adiabatic.

### Reforming Section

Following purification, and if necessary pre-reforming, the gaseous mixture comprising the hydrocarbon and steam is subjected to steam reforming in a reforming section comprising an autothermal reformer. It is preferred that there are no other reforming units (e.g. fired reformers or gas-heated reformers) other than the autothermal reformer in the reforming section.

In the present invention the gaseous mixture comprising the hydrocarbon and steam, having optionally first undergone pre-reforming, is fed to an autothermal reformer in which it is subjected to autothermal reforming. It is preferred that all of the purified hydrocarbon stream, having optionally first undergone pre-reforming, is fed to the autothermal reformer.

The autothermal reformer may comprise a burner disposed at the top of the reformer, to which the steam reformed gas and the oxygen-rich gas are fed, a combustion zone beneath the burner through which a flame extends, and a fixed bed of particulate steam reforming catalyst disposed below the combustion zone. In autothermal reforming, the heat for the endothermic steam reforming reactions is therefore provided by combustion of a portion of hydrocarbon in the pre-reformed feed gas. The pre-reformed gas is typically fed to the top of the reformer and the oxygen-rich gas fed to the burner, mixing and combustion occur downstream of the burner generating a heated gas mixture the composition of which is brought to equilibrium as it passes through the steam reforming catalyst. The autothermal steam reforming catalyst may comprise nickel supported on a refractory support such as rings or pellets of calcium aluminate, magnesium aluminate, alumina, titania, zirconia and the like. In a preferred embodiment, the autothermal steam reforming catalyst comprises a layer of a catalyst comprising Ni and/or Ru on zirconia over a bed of a Ni on alumina catalyst to reduce catalyst support volatilisation that can result in deterioration in performance of the autothermal reformer.

The oxygen-rich gas may comprise at least 50% vol O₂ and may be an oxygen-enriched air mixture however in the present invention the oxygen-rich gas preferably comprises at least 90% vol O₂, more preferably at least 95% vol O₂, most preferably at least 98% vol O₂, or at least 99% vol O₂, e.g. a pure oxygen gas stream, which may be obtained using a vacuum pressure swing adsorption (VPSA) unit or an air separation unit (ASU). The ASU may be electrically driven and is desirably driven using renewable electricity to further improve the efficiency of the process and minimise CO₂ emissions.

The amount of oxygen-rich gas added is preferably such that 45 to 65 moles of oxygen are added per 100 moles of carbon in the hydrocarbon fed to the process. Preferably the amount of oxygen added is such that the autothermally reformed gas leaves the autothermal reforming catalyst at a temperature in the range 800-1100° C. In a preferred embodiment, a small purge of steam may be added to the oxygen-rich gas to protect against reverse flow if the plant trips.

After leaving the autothermal reformer, the reformed gas is then typically cooled in one or more steps of heat exchange. Heat recovered during this cooling may be employed for reactants pre-heating and/or for heating water used to provide the steam employed in the steam reforming step. As described hereinafter, the recovered heat may additionally, or alternatively, be used in the carbon dioxide separation step.

### Water-Gas Shift Section

The reformed gas comprises hydrogen, carbon monoxide, carbon dioxide, steam, and a small amount of unreacted methane, and may also contain small amounts of inert gases such as nitrogen and argon. For example, in processes where all of the process steam is added upstream of the reforming unit operations, the hydrogen content of the autothermally-reformed gas may be in the range 35-45% vol and the CO content in the range 10-20% vol. In the current process, the hydrogen content of the reformed gas mixture is increased by subjecting it to one or more water-gas shift stages in a water-gas shift section thereby producing a hydrogen-enriched reformed gas stream and at the same time converting carbon monoxide to carbon dioxide. The reaction may be depicted as follows:

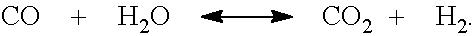

Optionally, but particularly where the steam to carbon ratio of the gaseous mixture fed to the pre-reformer is below 2.4:1, additional process steam may be added to the reformed gas to improve the equilibrium position in the water-gas shift stage. Thus, in some embodiments the process includes optionally adding steam to the reformed gas. Steam may be added to the reformed gas upstream of the water-gas shift section, for example upstream of a high-temperature shift stage. The amount of steam to be added will vary depending on the amount of steam in the gaseous mixture comprising hydrocarbon that is fed to the reforming stages. The amount of steam added is desirably commensurate with maximising carbon capture from the process, which is assisted by minimising carbon monoxide slip. Therefore, where steam is added to the reformed gas, the molar steam to dry gas ratio of the reformed gas is preferably at least 0.7:1, more preferably in the range of 0.7:1 to 0.9:1.

Where the reforming is performed with an excess of steam it is generally not necessary to add steam to the reformed gas mixture recovered from the autothermal reformer.

The outlet gases from the ATR typically have a temperature ~1000° C. which is in excess of the temperature needed for high-temperature shift. It is therefore preferred that the reformed gases are cooled, preferably by raising steam, to produce a partially cooled reformed gas which is sent to the water-gas shift section.

The partially cooled reformed gas is subjected in the water-gas shift section to one or more water-gas shift stages to form a hydrogen-enriched reformed gas stream, a “shifted” gas stream. The one or more water-gas shift stages may include stages of high-temperature shift, medium-temperature shift, isothermal shift and low-temperature shift.

Whereas the water-gas shift section may comprise a single shift stage employing a suitably stable and active shift catalyst, it is preferred that the water-gas shift section includes two or more water-gas shift stages comprising high-temperature shift, medium-temperature shift, isothermal shift and low-temperature shift.

High-temperature shift is operated adiabatically in a shift vessel with inlet temperature in the range 300-400° C., preferably 320-360° C., over a bed of a reduced iron catalyst, such as chromia-promoted magnetite. Alternatively, a promoted zinc-aluminate catalyst may be used. The partially cooled reformed gas is typically at a temperature of ~400° C. which is ideally suited to high-temperature shift. Therefore, in a preferred embodiment the water-gas shift section includes at least one high-temperature shift unit.

Medium-temperature shift and low-temperature shift stages may be performed using shift vessels containing supported copper-catalysts, particularly copper/zinc oxide/alumina compositions. In low-temperature shift, a gas containing carbon monoxide (preferably ≤6% vol CO on a dry basis) and steam (at a steam to total dry gas molar ratio in range 0.3 to 1.5) may be passed over the catalyst in an adiabatic fixed bed with an outlet temperature in the range 200 to 300° C. Typically, the inlet gas is the product of “high-temperature shift” in which the carbon monoxide content has been decreased by reaction over an iron-chromia catalyst at an outlet temperature in the range 400 to 500° C., followed by cooling by indirect heat exchange. The outlet carbon monoxide content from the low-temperature water-gas shift stage is typically in the range 0.1 to 1.0%, especially under 0.5% vol, on a dry basis. Alternatively, in medium-temperature shift, the gas containing carbon monoxide and steam is fed at a pressure in the range 15-50 bar abs to the catalyst at an inlet temperature typically in the range 200 to 240° C. although the inlet temperature may be as high as 280° C., and the outlet temperature is typically up to 300° C. but may be as high as 360° C.

A shift unit comprising a combination of high-temperature shift and low-temperature shift stages, each stage operated adiabatically, is preferred in the present process. Adiabatic operation of the shift stages results in an increase in the temperature of the shifted gas mixtures and subsequent heat exchange with one or more process fluids is generally desirable. Where the shift unit comprises a high-temperature shift stage, two stages of heat exchange are preferable in which a hot shifted gas mixture may be cooled by heat exchange with water under pressure and with the hydrocarbon. In a preferred arrangement, a hot shifted gas from a high-temperature shift stage is cooled in a first stage of heat exchange with the hydrocarbon and in a second stage of heat exchange with water under pressure.

Whereas the low-temperature shift and medium-temperature shift reactions may be operated adiabatically it is also possible to operate them isothermally, i.e. with heat exchange in the shift vessel such that the reaction in the catalyst bed occurs in contact with heat exchange surfaces. The coolant conveniently may be water under pressure such that partial, or complete, boiling takes place. The resulting steam can be used, for example, to drive a turbine for power or to provide process steam for the water-gas shift or steam reforming reactions. The water can be in tubes surrounded by catalyst or vice versa. Whereas the term “isothermal” is used, there may be a small increase in temperature of the gas between inlet and outlet, so that the temperature of the hydrogen-enriched reformed gas stream at the exit of the isothermal shift converter may be between 1 and 25 degrees Celsius higher than the inlet temperature.

Following the one or more shift stages, the hydrogen-enriched reformed gas is cooled to a temperature below the dew point so that the steam condenses. The liquid water condensate may then be separated using one or more, gas-liquid separators, which may have one or more further cooling stages between them. Any coolant may be used. Preferably, cooling of the hydrogen-enriched reformed gas stream is first carried out in heat exchange with the process condensate. As a result, a stream of heated water, which may be used to supply some or all of the steam required for reforming, is formed. Thus, in one embodiment condensate recovered from the hydrogen-enriched reformed gas is used to provide at least a portion of steam for the gas mixture fed to the steam reforming step in the autothermal reformer. Because the condensate may contain ammonia, methanol, hydrogen cyanide and CO₂, returning the condensate to form steam offers a useful way of returning hydrogen and carbon to the process.

One or more further stages of cooling are desirable. The cooling may be performed in heat exchange in one or more stages using demineralised water, air, or a combination of these. In a preferred embodiment, cooling is performed in heat exchange with one or more liquids in the CO₂ separation unit. In a particularly preferred arrangement, the hydrogen-enriched reformed gas stream is cooled in heat exchange with condensate followed by cooling with CO₂ reboiler liquid. The cooled shifted gas may then be fed to a first gas-liquid separator, the separated gas further cooled with water and/or air and fed to a second separator, before further cooling with water and/or air and feeding to a third separator. Two or three stages of condensate separation are preferred. Some or all of the condensate may be used to generate steam for the steam reforming. Any condensate not used to generate steam may be sent to water treatment as effluent.

### Carbon Dioxide Separation Unit

The carbon dioxide separation stage may be performed using a physical wash system or a reactive wash system, preferably a reactive wash system, especially an amine wash system. The carbon dioxide may be separated by an acid gas recovery (AGR) process. In the AGR process, the de-watered hydrogen-enriched reformed gas stream (i.e. the de-watered shifted gas) is contacted with a stream of a suitable absorbent liquid, such as an amine, particularly methyl diethanolamine (MDEA) solution so that the carbon dioxide is absorbed by the liquid to give a laden absorbent liquid and a gas stream having a decreased content of carbon dioxide. The laden absorbent liquid is then regenerated by heating and/or reducing the pressure, to desorb the carbon dioxide and to give a regenerated absorbent liquid, which is then recycled to the carbon dioxide absorption stage. Alternatively, methanol or a glycol may be used to capture the carbon dioxide in a similar manner as the amine. In a preferred arrangement, at least part of the heating to regenerate the absorbent liquid is performed using steam generated in the one or more fired heaters. If the carbon dioxide separation step is operated as a single pressure process, i.e. essentially the same pressure is employed in the absorption and regeneration steps, only a little recompression of the recycled carbon dioxide will be required.

The recovered carbon dioxide, e.g. from the AGR, may be compressed and used for the manufacture of chemicals, sent to storage or sequestration, used in enhanced oil recovery (EOR) processes or used in the production of other chemicals. Compression may be accomplished using an electrically driven compressor powered by renewable electricity. In cases where the CO₂ is to be compressed for storage, transportation or use in EOR processes, the CO₂ may be dried to prevent liquid water present in trace amounts, from condensing. For example, the CO₂ may be dried to a dew point ≤−10° C. by passing it through a bed of a suitable desiccant, such as a zeolite, or contacting it with a glycol in a glycol drying unit.

Upon the separation of the carbon dioxide, the process provides a crude hydrogen gas stream. The crude hydrogen stream may comprise 85-99% vol hydrogen, preferably 90-99% vol hydrogen, with the balance comprising methane, carbon monoxide, carbon dioxide and inert gases. Whereas this hydrogen gas stream is pure enough for many duties, in the present invention, the crude hydrogen gas stream is passed to a purification unit to provide a purified hydrogen gas and an off-gas, so that the fuel gas may be used in the process as an alternative to external fuel sources in order to minimise the CO₂ emissions from the process.

### Purification Unit

The role of the purification unit is to receive a crude hydrogen gas stream from the water-gas shift section and separate it into a purified hydrogen gas stream and an off-gas stream. Any suitable purification unit may be used. Preferred examples include a membrane system, a temperature swing adsorption system, or a pressure swing adsorption system. Such systems are commercially available. The purification unit is preferably a pressure swing adsorption unit or a temperature swing adsorption unit. Such units comprise regenerable porous adsorbent materials that selectively trap gases other than hydrogen and thereby purify it. The purification unit produces a pure hydrogen stream preferably with a purity greater than 99.5% vol, more preferably greater than 99.9% vol, which may be compressed and used in downstream power or heating process, for example, by using it as fuel in a gas turbine (GT) or by injection into a domestic or industrial networked gas piping system. The pure hydrogen may also be used in a downstream chemical synthesis process. Thus, the pure hydrogen stream may be used to produce ammonia by reaction with nitrogen in an ammonia synthesis unit. Alternatively, the pure hydrogen may be used with a carbon dioxide-containing gas to manufacture methanol in a methanol production unit. Alternatively, the pure hydrogen may be used with a carbon-monoxide containing gas to synthesise hydrocarbons in a Fischer-Tropsch production unit. Any known ammonia, methanol or Fischer-Tropsch production technology may be used. Alternatively, the hydrogen may be used to upgrade hydrocarbons, e.g. by hydro-treating or hydro-cracking hydrocarbons in a hydrocarbon refinery, or in any other process where pure hydrogen may be used. Compression may again be accomplished using an electrically driven compressor powered by renewable electricity.

### Recycle

The off-gas stream is split into a fuel gas stream and a recycle stream (step (viii)). The fuel gas stream is fed to one or more fired heaters used to heat one or more process streams within the process. The recycle stream is then compressed (step (ix)) and split into a hydrodesulphurisation recycle stream and a process recycle stream (step (x)). The hydrodesulphurisation recycle stream is fed to the hydrodesulphurisation unit (step (xi)) to provide hydrogen for the reactions taking place there. The process recycle stream is returned to one or more locations (step (xii)). The process recycle stream may be reintroduced to the process at various different locations (arrangements (xii-a) to (xii-d)).

The relative ratio of the mass flows of fuel gas:process recycle stream:hydrodesulfurisation recycle stream depends on several factors including the demand on the fired heater, the H₂ demand for the dehydrodesulfurisation unit, and the H₂ content of the hydrogen-containing off-gas stream. The proportion used as process recycle is determined by subtracting the fraction required for the fired heater duty, then subtracting the fraction required for the HDS duty. The remainder is sent for recycle.

In an embodiment the process recycle stream is reintroduced to the process downstream from the hydrodesulphurisation unit and upstream from the autothermal reformer (arrangement (xii-a)). In connection with arrangement (xii-a) if a pre-reformer is present then the process recycle stream is preferably reintroduced downstream from the pre-reformer and upstream from the autothermal reformer. An advantage of this arrangement is that is provides another opportunity to convert residual hydrocarbons in the off-gas into hydrogen and therefore improve the hydrogen yield per unit of hydrocarbon. A further advantage of this arrangement is that is provides another opportunity to convert residual carbon monoxide in the off-gas into carbon dioxide, since it will have a further pass through the water-gas shift section. This reduces carbon monoxide emissions from the process. A yet further advantage of this arrangement is that it provides another opportunity to capture residual carbon dioxide in the off-gas, since it will have a further pass through the carbon dioxide separation unit. It will be appreciated that the feed to the autothermal reformer is typically much hotter than the off-gas from the purification unit and the off-gas may need to be heated before reintroduction.

In one embodiment the recycle stream is reintroduced to the process downstream from the autothermal reformer and upstream from the water-gas shift section (arrangement (xii-b)). This arrangement provides an opportunity to reduce the carbon monoxide and carbon dioxide content of the off-gas.

In one embodiment the recycle stream is reintroduced to the process downstream from the water-gas shift section and upstream from the carbon dioxide separation unit (arrangement (xii-c)). While this arrangement provides an opportunity to reduce the carbon dioxide content of the off-gas, the carbon dioxide content of the off-gas is generally already very low and therefore this arrangement is least preferred of options xii-a to xii-d.

In a preferred embodiment the recycle stream is reintroduced to the process at a location which is downstream from the carbon dioxide removal unit and upstream from the purification unit (arrangement (xii-d)). This arrangement provides a further opportunity to separate hydrogen and unconverted hydrocarbons.

It will be appreciated that more complicated arrangements are possible, e.g. where the recycle stream is introduced at two or more different locations out of the options specified. For simplicity of design it is preferred that the process recycle stream is returned to the process at only a single location of (xii-a) to (xii-d), most preferably at location (xii-d).

The combination of steps as described herein provides sufficient fuel gas to heat the process streams used in the process without significant additional fuel during normal operation. The volume of supplemental fuel in the process is desirably kept to a minimum to maximise the CO₂ capture efficiency. The amount of the supplemental fuel, e.g. natural gas, fed to the one or more fired heaters along with the fuel gas is preferably less than 5% vol of the total fuel provided, more preferably less than 3% vol of the total fuel provided, most preferably less than 2% of the total fuel provided.

In some circumstances, such as during start-up of the process, it may be necessary to supplement the fuel gas with a hydrocarbon fuel temporarily, but this should not materially reduce the efficiency of the process, and during normal operation the fuel gas recovered from the purification unit will be the main source of fuel provided to the one or more fired heaters.

In some embodiments, a single fired heater fuelled at least in part by the fuel gas is sufficient to heat the hydrocarbon, the reformed gas recovered from the pre-reforming stage upstream of the autothermal reforming stage, and water to generate at least part of the steam for the process.

Whereas all the process streams requiring heating may be heated in a single fired heater, in a preferred arrangement one fired heater is used for process gas streams containing hydrocarbon and/or hydrogen and another is used solely to boil water for steam generation. The latter may therefore also be described as a boiler. The fuel gas may therefore be divided between a first fired heater used to heat hydrocarbon- and/or hydrogen-containing streams and a second fired heater used to boil water to generate steam. Using two fired heaters in this way provides a number of distinct advantages; it allows for steam to be raised within the second fired heater and thereby used as part of the plant start-up; it allows steam to be generated in the second fired heater whilst the plant is being shut down and supplied to the plant during the shut-down process; it makes start-up easier as the first and second fired heaters can be operated independently and eliminates coils being heated in a no-flow regime; and separating the first fired heater allows nitrogen to be warmed up as part of the start-up procedure whilst the second fired heater is either being brought into service or is itself being started up. The fuel gas split to the first and second fired heaters may be in the ranges of 10-90% vol to 90-10% vol respectively but is preferably 60-80% vol to the first fired heater and 40-20% vol to the second fired heater.

Steam generated in the second fired heater may be used to heat the CO₂ absorbent liquid in the carbon dioxide separation unit. The second fired heater may also be used to superheat steam recovered from the steam drum coupled to a waste-heat boiler heated by the reformed gas. The waste-heat boiler preferably is also used to generate steam used to pre-heat the oxygen-rich gas and/or to provide process steam to be added upstream of the water-gas shift section to maximise the conversion to hydrogen and carbon dioxide. A portion of the steam from the waste-heat boiler may also be passed to a steam expander to generate power.

### EXAMPLES

### Example 1 (Comparative)

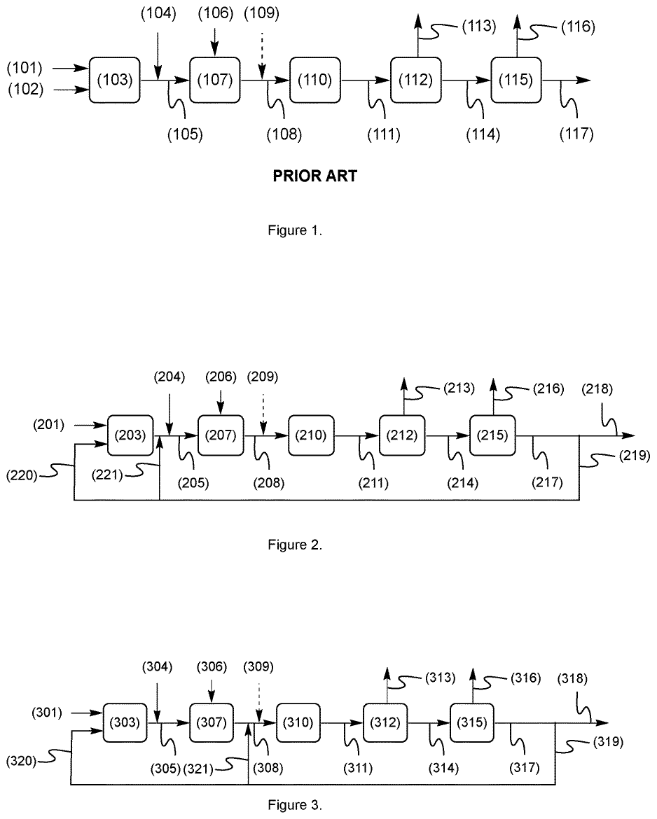

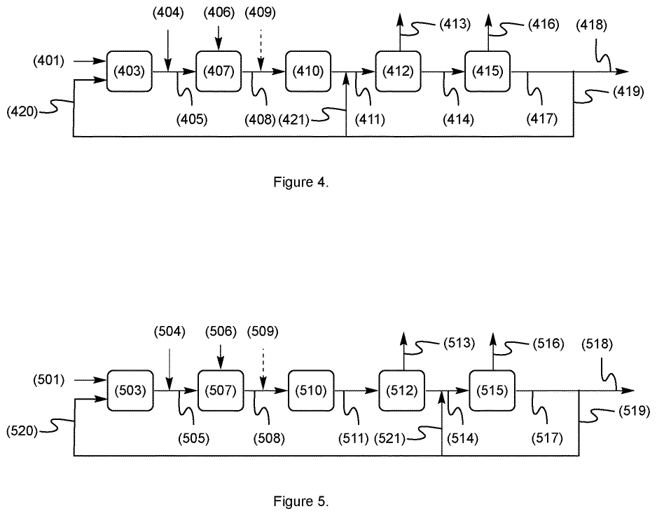

This example corresponds to the flowsheet depicted in FIG. 1 of WO2022/003313A1. Selected heat and mass balance calculations from the example modelled in WO2022/003313A1 are shown in Table 1. A simplified version of the flowsheet is depicted in FIG. 1.

### Example 2 (According to Invention)

The flowsheet depicted in WO2022/003313A1 was modified by splitting the off-gas stream into a fuel gas stream and a recycle stream. The recycle stream was itself split into a process recycle stream (519) and a desulfurisation recycle stream (520). This example corresponds to the arrangement shown in FIG. 5. Heat and mass balance calculations for selected streams are shown in Table 2.

TABLE 1

| Stream # in | | | | | | | | | |
|---|---|---|---|---|---|---|---|---|---|
| WO'313 | 10 | 12 | 44 | 66 | 102 | 110 | 112 | 116 | 122 |
| Stream in FIG. 1 | 101 | 102 | 105 | 108 | 111 | 113 | 114 | 116 | 117 |
| Temperature | 40 | 70 | 470 | 360 | 71 | 40 | 50 | 40 | 40 |
| (° C.) | | | | | | | | | |
| Pressure (bara) | 41.3 | 43.5 | 39.8 | 37.0 | 33.6 | 1.5 | 33.6 | 33.1 | 1.5 |
| Mass flow | 32.4 | 0.1 | 122.6 | 158.8 | 100.6 | 85.8 | 13.7 | 10.0 | 3.7 |
| (ton/h) | | | | | | | | | |
| Composition | | | | | | | | | |
| (mol %) | | | | | | | | | |
| H₂O | 0.61 | — | 64.01 | 41.56 | 1.11 | — | 0.37 | — | 2.95 |
| H₂ | — | 100.00 | 8.02 | 39.76 | 72.50 | — | 98.24 | 100.00 | 85.97 |
| CO | — | — | 0.05 | 11.61 | 0.47 | — | 0.64 | — | 5.09 |
| CO₂ | 0.15 | — | 2.42 | 6.70 | 25.44 | 100.00 | 0.10 | — | 0.82 |
| N₂ | 0.19 | — | 0.05 | 0.09 | 0.18 | — | — | — | 1.90 |
| CH₄ | 92.17 | — | 25.33 | 0.20 | 0.29 | — | 0.39 | — | 3.13 |
| C₂H₆ | 6.32 | — | — | — | — | — | — | — | — |
| C₃H₈ | 0.52 | — | — | — | — | — | — | — | — |
| C₄H₁₀ | 0.05 | — | — | — | — | — | — | — | — |
| C₅H₁₂ | — | — | — | — | — | — | — | — | — |
| CH₃OH | — | — | — | — | 0.01 | — | — | — | — |
| NH₃ | — | — | — | — | — | — | — | — | 0.03 |

TABLE 2

| Stream in | | | | | | | | | | |
|---|---|---|---|---|---|---|---|---|---|---|
| FIG. 5 | 501 | 520 | 505 | 508 | 511 | 513 | 514 | 516 | 518 | 521 |
| Temperature | 20 | 140 | 450 | 363 | 65 | 40 | 40 | 45 | 139 | 140 |
| (° C.) | | | | | | | | | | |
| Pressure | 50.0 | 51.0 | 41.7 | 37.4 | 33.8 | 1.30 | 33.5 | 50.0 | 2.60 | 51.3 |
| (bara) | | | | | | | | | | |
| Mass flow | 29.14 | 0.515 | 70.25 | 123.7 | 87.15 | 76.13 | 16.17 | 9.22 | 2.24 | 4.09 |
| (ton/h) | | | | | | | | | | |
| Composition | | | | | | | | | | |
| (mol %) | | | | | | | | | | |
| H₂O | — | 0.34 | 57.40 | 39.07 | 0.84 | 5.66 | 0.24 | 99.84 | 1.65 | 0.34 |
| H₂ | — | 66.60 | 0.84 | 39.91 | 71.63 | 0.63 | 94.92 | — | 65.77 | 66.60 |
| CO | — | 14.10 | 0.32 | 15.26 | 0.64 | — | 2.00 | — | 13.86 | 14.10 |
| CO₂ | 2.00 | 0.14 | 0.73 | 5.01 | 25.92 | 93.64 | 0.02 | 0.10 | 0.14 | 0.14 |
| N₂ | 0.89 | 4.11 | 0.43 | 0.19 | 0.26 | — | 0.67 | 0.06 | 4.06 | 4.11 |
| Ar | — | 0.87 | 0.01 | 0.06 | 0.08 | — | 0.18 | — | 0.86 | 0.87 |
| CH₄ | 89.00 | 13.77 | 36.87 | 0.48 | 0.63 | 0.01 | 1.96 | — | 13.58 | 13.77 |
| C₂H₆ | 7.00 | — | 2.88 | — | — | — | — | — | — | — |
| C₃H₈ | 1.00 | — | 0.41 | — | — | — | — | — | — | — |
| C₄H₁₀ | 0.10 | — | 0.04 | — | — | — | — | — | — | — |
| C₅H₁₂ | 0.01 | — | | — | — | — | — | — | — | — |
| CH₃OH | — | 0.01 | 0.05 | — | 0.02 | 0.06 | — | — | 0.01 | 0.01 |
| NH₃ | — | 0.06 | 0.01 | 0.01 | — | — | 0.01 | — | 0.07 | 0.06 |

1. A process for the production of hydrogen comprising the steps of:
(i) passing a hydrogen stream and a feed stream comprising hydrocarbons to a hydrodesulphurisation unit and carrying out hydrodesulphurisation to produce a purified hydrocarbon stream;
(ii) adding steam to the purified hydrocarbon stream to produce a gaseous mixture comprising hydrocarbons and steam;
(iii) subjecting the gaseous mixture comprising hydrocarbons and steam to steam reforming in a reforming section comprising an autothermal reformer to generate a reformed gas mixture;
(iv) increasing the hydrogen content of the reformed gas mixture by subjecting it to one or more water-gas shift stages in a water-gas shift section to provide a hydrogen-enriched reformed gas;
(v) cooling the hydrogen-enriched reformed gas and separating condensed water therefrom to provide a de-watered hydrogen-enriched reformed gas;
(vi) passing the de-watered hydrogen-enriched reformed gas to a carbon dioxide separation unit to provide a carbon dioxide gas stream and a crude hydrogen gas stream;
(vii) passing the crude hydrogen gas stream from the carbon dioxide removal unit to a purification unit to provide a purified hydrogen gas stream and a hydrocarbon-containing off-gas stream;
(viii) splitting the off-gas stream into a fuel gas stream and a recycle stream, wherein the fuel gas stream is fed to one or more fired heaters used to heat one or more process streams within the process;
(ix) compressing the recycle stream;
(x) splitting the compressed recycle stream into a hydrodesulphurisation recycle stream and a process recycle stream;
(xi) feeding the hydrodesulphurisation recycle stream to the hydrodesulphurisation unit;
(xii) returning the process recycle stream to one or more locations selected from:
(xii-a) downstream from the hydrodesulphurisation unit and upstream from the autothermal reformer;
(xii-b) downstream from the autothermal reformer and upstream from the water-gas shift section;
(xii-c) downstream from the water-gas shift section and upstream from the carbon dioxide separation unit; or
(xii-d) downstream from the carbon dioxide separation unit and upstream from the purification unit.

2. The process according to claim 1, wherein the process comprises a step of pre-reforming either upstream from the hydrodesulphurisation unit, or downstream from the hydrodesulphurisation unit and upstream from the autothermal reformer.

3. The process according to claim 1, wherein there are no other reforming units other than the autothermal reformer in the reforming section.

4. The process according to claim 1, wherein the steam to carbon ratio of the gaseous mixture comprising hydrocarbons and steam at the inlet to the autothermal reformer in step (iii) is from 0.9:1 to 3.5:1.

5. The process according to claim 4, wherein the steam to carbon ratio of the gaseous mixture comprising hydrocarbons and steam at the inlet to the gas-heated reformer in step (iii) from 0.9:1 to 2.4:1 and further steam is added to the reformed gas mixture upstream of the water-gas shift section.

6. The process according to claim 1, wherein the water-gas shift section comprises at least one high temperature shift unit.

7. The process according to claim 1, wherein the recycle stream is returned to the process at location (xii-d).

8. The process according to claim 1, wherein the process recycle stream is returned to the process at a single location.

9. The process according to claim 1, wherein the steam added in step (ii) is generated by combusting the fuel gas stream in said one or more fired heaters.

10. A chemical plant comprising:
(i) a hydrodesulphurisation unit arranged to accept a hydrogen stream and a feed stream comprising hydrocarbons and to carry out hydrodesulphurisation to produce a purified hydrocarbon stream;
(ii) means for adding steam to the purified hydrocarbon stream to produce a gaseous mixture comprising hydrocarbons and steam;
(iii) a reforming section comprising an autothermal reformer, arranged to accept said gaseous mixture comprising hydrocarbons and steam to produce a reformed gas mixture;
(iv) a water-gas shift section comprising one or more water-gas shift stages arranged to accept said reformed gas mixture to produce a hydrogen-enriched reformed gas;
(v) means for cooling the hydrogen-enriched reformed gas and separating condensed water therefrom to produce a de-watered hydrogen-enriched reformed gas;
(vi) a carbon dioxide separation unit arranged to accept said de-watered hydrogen-enriched reformed gas to produce a carbon dioxide gas stream and a crude hydrogen gas stream;
(vii) a purification unit arranged to accept said crude hydrogen gas stream and to produce a purified hydrogen gas stream- and a hydrocarbon-containing off-gas stream;
(viii) means for splitting the off-gas stream into a fuel gas stream and a recycle stream, wherein the fuel gas stream is fed to one or more fired heaters used to heat one or more process streams within the process;
(ix) means for compressing the recycle stream;
(x) means for splitting the compressed recycle stream into a hydrodesulphurisation recycle stream and a process recycle stream;
(xi) means for feeding the hydrodesulphurisation recycle stream to the hydrodesulphurisation unit;
(xii) means for returning the process recycle stream to one or more locations selected from:
(xii-a) downstream from the hydrodesulphurisation unit and upstream from the autothermal reformer;
(xii-b) downstream from the autothermal reformer and upstream from the water-gas shift section;
(xii-c) downstream from the water-gas shift section and upstream from the carbon dioxide separation unit; or
(xii-d) downstream from the carbon dioxide separation unit and upstream from the purification unit.

11. The chemical plant according to claim 10, wherein the plant comprises a pre-reformer either upstream from the hydrodesulphurisation unit, or downstream from the hydrodesulphurisation unit and upstream from the autothermal reformer.

12. The chemical plant according to claim 10, wherein there are no other reforming units other than the autothermal reformer in the reforming section.

13. The chemical plant to claim 10, wherein the water-gas shift section comprises at least one high temperature shift unit.

14. The chemical plant according to claim 10, wherein the recycle stream is returned to the process at location (xii-d).

15. The chemical plant according to claim 10, wherein the process recycle stream is returned to the process at a single location.

16. The chemical plant according to claim 10, wherein the steam added in step (ii) is generated by combusting the fuel gas stream in said one or more fired heaters.
